(19) United States
(12) Patent Application Publication
(10) Pub. No.: US 2008/0174411 A1
(43) Pub. Date: Jul. 24, 2008

(54) Method of Controlling Individual Related Information

(75) Inventors: Magnus Rehn, Bromma (SE); Anders Holmlund, Kungsangen (SE)

Correspondence Address: YOUNG & THOMPSON, 209 Madison Street, Suite 500, ALEXANDRIA, VA, 22314, US

(73) Assignee: Tag-Master AB, Kista (SE)

(21) Appl. No.: 11/883,836

(22) PCT Filed: Jan. 30, 2006
(86) PCT No.: PCT/SE06/00130

§ 371 Date: Oct. 3, 2007

(30) Foreign Application Priority Data
Feb. 9, 2005 (SE) 0500317-3

(51) Int. Cl. H04Q 5/22

(52) U.S. Cl. 340/10.5

(57) ABSTRACT

Method of controlling individual related information via an identification system in which a transponder reflects an inquiry signal from a communicator, where the reflected signal has been modulated with data that can be read by the communicator, wherein the data identifies individuals connected to the system and is stored in the transponder memory, and the communicator is connected to a superordinate data system. The method is characterized by causing services for the individuals to be controlled via the superordinate data system; the services include causing the superordinate data system to activate devices and computer services via additional data systems for performing services for connected individuals. Information concerning one or more services related to each connected individual is stored in the superordinate data system, which is caused to activate the devices and/or computer services via the additional data systems upon identification of a connected individual via the identification system.

The present invention relates to a method of controlling individual related information.

The invention relates to a system of the kind used to carry out authority checks on individuals, for instance in respect of companies, authorities, airports, arenas and other places where an identification system is required.

Known automatic identification systems normally include individual-carried ID-tags and tag-reading equipment.

Known automatic identification systems that utilize radio frequencies, so-called RFID (Radio Frequency Identification) comprises at least one transponder and at least one communicator. A known type of transponder includes an antenna, a modulator, a memory and a modulator-controlling logic circuit. Such a transponder is designed to receive a signal sent by the communicator and to reflect this signal in a modulated state. The communicator is designed to receive and to read the modulated signal reflected by the transponder.

An ID-tag comprising a transponder can be applied to an individual or to an object to be identified. The information carried by the transponder can be read by a communicator over a given small range, such as a range of 5 metres for instance.

The above mentioned problem is solved by means of the present invention.

The present invention thus relates to a method of controlling individual related information by means of an identification system in which a transponder reflects an inquiry signal sent from a communicator, where the reflected signal has been modulated with data that can be read by the communicator, wherein the data includes information concerning the identification of connected individuals and is stored in the transponder memory, wherein the communicator is connected to a superordinate data system, and wherein the system is characterized by causing services for said individuals to be controlled via said superordinate data system, wherein said services include the step of causing the superordinate data system to actuate devices and data services via further data systems so as to execute services for connected individuals, wherein information concerning one or more services related to each connected individual is/are stored in the superordinate data system, and wherein the superordinate data system is caused to activate said devices and/or data services via further data systems when a connected individual is identified by the identification system.

The invention will now be described more specifically with reference to an exemplifying embodiment of the invention illustrated in the accompanying drawing.

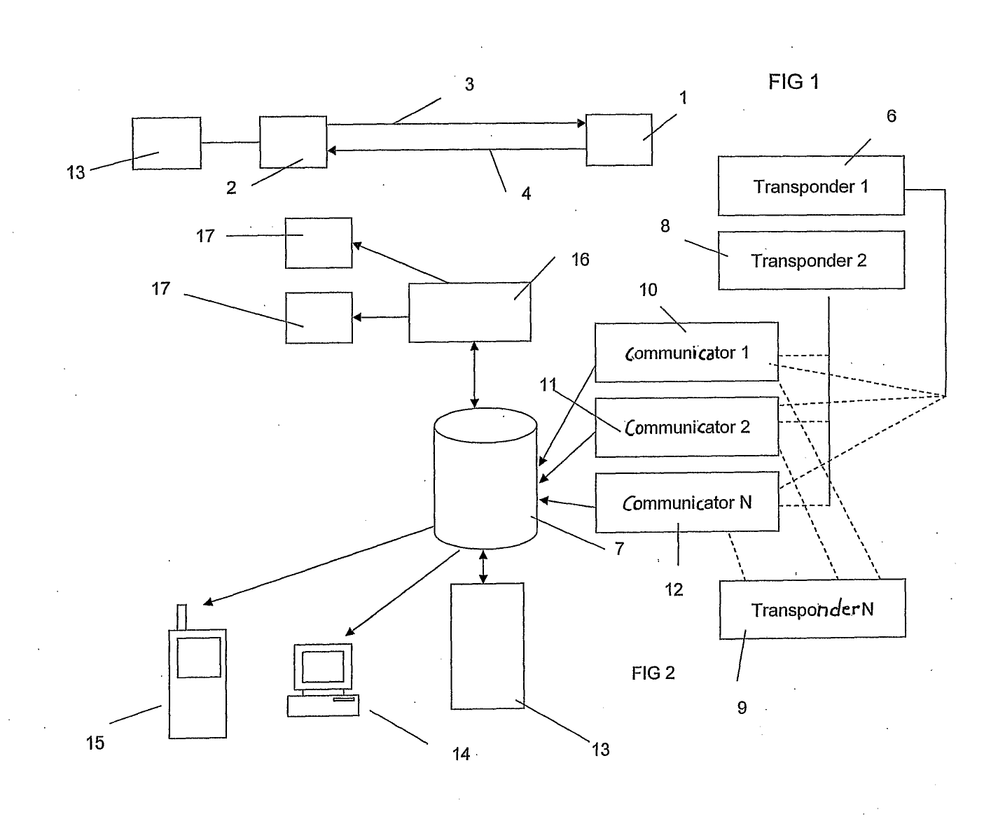

The system illustrated in the outline sketch of FIG. 1 comprises a transponder 1 that includes an antenna and a memory. Also included in the system shown in FIG. 1 is a communicator 2 that includes an antenna, a memory, and a processor, and also includes a data system 9. Also illustrated in FIG. 1 are an inquiry signal 3 and a reflected, modulated response signal 4.

The identification system includes one such communicator 2, which continuously emits an inquiry signal 3. When a transponder 1 is situated close to a communicator 2, the signal 3 will be received by the transponder antenna, wherewith the signal is reflected and sent as a modulated information carrying response signal 4. This information includes data stored in the transponder memory, in particular information concerning identification data for an object or an individual. The communicator is designed to decode the received response signal and therewith read said information.

The data has an identification purpose regarding the individuals connected to the present system. The communication link described with reference to FIG. 1 belongs to well known technology. The present invention utilises this technology.

FIG. 2 illustrates three transponders 6, 8, 9 and three communicators 10, 11, 12.

The communicators 10, 11, 12 are connected to a superordinate data system 13, which includes a data base 7. The superordinate data system is also connected to one or more further data systems 16. The superordinate data system is also connected to one or more personal computers 14 for the input of data to the superordinate data system and/or the output of data from the system. The superordinate data system will preferably also be able to output data to mobile telephones 15 through the agency of voice messages or SMS-messages for instance.

The aforesaid further computer systems 16 may be situated at other geographical stations where they are adapted to activate and administer different services.

According to the present invention, services are controlled in respect of said individuals via the superordinate data system 13. These services include causing the superordinate data system 13 to activate devices and computer services 17 via additional data systems 16 so as to carry out services for connected individuals. Information concerning one or more services related to each connected individual is stored in the database 7 of the superordinate data system 13. The superordinate data system 13 is caused to activate said devices and/or computer services 17 via the further data systems 16 in response to identification of a connected individual by means of the identification system 1-12.

Thus, when a communicator 10-12 has read a transponder 6, 8, 9 and the superordinate data system 13 identifies an individual or an object, such as an automotive vehicle, the data system 13 is caused to read the services stored in the database 7 with respect to the individual concerned. The superordinate data system 13 is then caused to send information to a further data system 16 informing said system of the service to be performed.

The service in question can be determined by the communicator that has read the transponder 6, 8, 9. For example, if one of the services for an individual involves the parking of a motor vehicle in one of several available parking buildings and another service is to automatically bill a parking cost to a given account, such as to a VISA account and a communicator in a certain parking building reads the transponder 6, 8, 9 an entrance barrier for instance will be opened so that the individual concerned is able to drive into the car park. When parking is terminated and the individual intends to drive out of the car park, the transponder is again read at the exit barrier, which therewith opens.

Opening of the barriers is effected in response to the superordinate data system having received information from the communicator that has read the transponder, wherewith the superordinate data system has identified the individual and has read the service profile of the individual stored in the data base system 7 and has thereafter caused the data system that administers the car park to reveal that the individual concerned has permission to park hisiher vehicle.

Subsequent to the exit barrier having been opened, the information read by a communicator at the exit barrier is sent to the superordinate data system, wherewith the superordinate data system is caused to bill the individual's (VISA-account).

Thus, the services to be activated are initiated and controlled by the superordinate data system 16.

According to a highly preferred embodiment of the invention the superordinate data system 16 is caused to be activated to perform services in steps, wherewith mutually sequential steps are included in a successive chain of steps. This chain is illustrated above by two steps, namely the step of allowing a vehicle to be parked and the step of billing the parking cost.

Other applications may include three or more successive steps.

Another highly preferred embodiment includes one or more steps comprising one or more individual choices, where a choice in one step causes the superordinate data system to carry out one or more successive services in accordance with the choice made.

According to another embodiment of the invention, the method is caused to be carried out in one or more closed data systems in which said services are provided.

There now follows an example which describes the procedure when the invention is carried out in respect of successive choices. An individual intends to motor from Stockholm city to Arlanda airport in order to catch a flight. The individual travels by car and may choose to park the car in a central car park close to the “Arlanda Express” exit (the Arlanda Express being an airport train service). If the individual makes this choice, a communicator at the car park entrance will read the transponder and the superordinate data system will be activated in the manner described above.

Provided that the individual concerned has given his service profile to the data base 7 including his desire to travel by the airport train, the individual will be shown the current times of the train departures in the form of an SMS-message as a result of the aforesaid communicator having read the individuals transponder. When the individual passes a ticket barrier, a communicator located at the barrier is able to read the individual's transponder, wherewith the superordinate data systems sends information to the ticket barrier causing a ticket to be issued, said data superordinate system then billing the individual's account accordingly.

When the individual does not wish to take the airport train, but instead wishes to drive directly to Arlanda he can either drive into a car park building at Arlanda or to a drive-in barrier of a surface car parking area. Regardless of the choice made by the individual, the entrance barriers concerned will be opened after a communicator has read the individuals transponder and the individual will be billed automatically for the service.

The following example relates to the case when the transponder is tied to an individual to his or her capacity of the driver of the vehicle concerned. For example, if the person is a truck driver and is equipped with a transponder, the superordinate data system may be included in a logistic system for a freight system. When the truck travels on the highway network, or road network, communicators may be provided at customs and excise stations and at toll bridges and toll roads or highways, wherewith billing of the costs incurred can be carried out in the manner described above. Depending on the route chosen by the driver, overnight lodgings can also be booked in accordance with a predetermined list in said data base 7 and also with the times at which the transponder was read. Provided that the overnight facility is equipped with communicators, the cost of the overnight lodging can also be billed in the manner described above. When the truck arrives at a truck terminal, a communicator located at the entrance to the terminal is able to read the transponder, wherewith the superordinate data system fetches information indicating which unloading bay the truck shall use in order to off-load. The superordinate data system may include information concerning the transmission of this to a computer onboard the truck or as an SMS-message or a voice message over the mobile telephone network. When unloading of the truck is completed, information can be sent to the truck indicating the loading bay that shall be used for re-loading purposes. When the truck has been loaded, relevant information concerning the route to its final destination can be sent, e.g. to a computer installed in the truck.

Although the invention has been described above with reference to two examples, it will be understood that the invention is far from being restricted to these particular applications and that it has a much wider application area.

The general case is that when a person is identified at a given geographical point there is activated a service package which is unique to that identified person.

A person who is connected to the system can be logged into the system when passing such a geographical point anywhere in the world, wherewith the system contains or obtains information that can be utilised by said person at this location point. Information can be transferred to said person via, for instance, a mobile communications network.

The information utilised is stored, inter alia, as a service profile in said data base. The service profile in combination with the geographical location of the reading communicator may, for instance, control offers, price levels, accesses etc.

It may also concern an “order” pre-entered by said person into the system and connected to the time or place concerned.

Such a system enables the person to be guided, for instance, from the point of logging into the system to a following point which, in turn, triggers new activities/information etc. etc, therewith enabling coherent chains of information and activities of the most disparate kinds to be built-up and to be kept active and fully extended over long periods of time and functioning worldwide.

Consequently, the present invention shall not be considered as being limited to the exemplifying embodiment described above, since variations and modifications can be made within the scope of the accompanying claims.

1-4. (canceled)

5. A method of controlling individual related information by means of an identification system in which a transponder (1) reflects an inquiry signal (3) from a communicator (2), where said reflected signal (4) has been modulated with data that can be read by the communicator (2), wherein said data has the object of identifying individuals connected to the system and is stored in the transponder memory, wherein the communicator (2) is connected to a superordinate data system (13), and where the services for said individuals to be controlled via the superordinate data system (13), where said services include causing the superordinate data system (13) to activate devices and computer services (17) via additional data systems (16) for performing services for connected individuals, characterised in that information concerning one or more services related to each connected individual is stored in the superordinate data system (13), in that the superordinate data system (13) is caused to activate said devices and/or computer services (17) via said additional data systems (16) depending on the service profile of the individual and the geographical position of the reading communicator when identification of a connected individual by means of the identification system (1-12) takes place and in that the superordinate data system (13) is caused to be activated to execute services in steps, where mutually sequential steps are included in a succession of steps.

6. A method according to claim 5, characterized by causing one or more steps to include one or more choices for the individual and also causing the superordinate data system (13) to execute one or more successive services in accordance with the choice made by said individual.

7. A method according to claim 5, characterized by causing the method to be carried out in one or more closed data systems (16) in which said services are provided.

8. A method according to claim 6, characterized by causing the method to be carried out in one or more closed data systems (16) in which said services are provided.
